(19) United States
(12) Patent Application Publication
(10) Pub. No.: US 2002/0073175 A1
(43) Pub. Date: Jun. 13, 2002

(54) Updating world wide web pages in a storage area network environment

(76) Inventors: Rodney A. DeKoning, Augusta, KS (US); William P. Delaney, Wichita, KS (US); James Lynn, Rose Hill, KS (US)

Correspondence Address: LSI Logic Corporation, 1551 McCarthy Blvd., M/S: D-106 Patent Department, Milpitas, CA, 95035, US

(21) Appl. No.: 09/735,362

(22) Filed: Dec. 11, 2000

(51) Int. Cl. G06F 15/173; G06F 15/16

(52) U.S. Cl. 709/219; 707/203

(57) ABSTRACT

An exemplary storage system for maintaining content (e.g. a Web site) for a shared network (e.g. the World Wide Web) includes content servers (e.g. Web servers) and storage devices connected together in a storage area network (SAN). A production server is used to develop new data to update the content of the Web site. The production server distributes the new data through the SAN to the storage devices, bypassing the Web servers. The Web servers are not involved in transferring the new data, so the Web servers preferably remain primarily dedicated to servicing Web page accesses from users across the Web.

### FIELD OF THE INVENTION

This invention relates to apparatus and methods for data storage in a computerized network or system. More particularly, the present invention relates to updating data on storage devices in which the data is used for World Wide Web “pages” sent to Web users by conventional Web servers. The Web users experience less latency and greater accessibility during the updates since the update data is transferred directly to the storage devices, instead of passing through the Web servers.

### BACKGROUND OF THE INVENTION

A World Wide Web site that services a relatively large number of accesses to the “pages” (i.e. data) on the Web site typically uses more than one Web server to respond to the page accesses. Each Web server uses one or more corresponding storage devices which contain data for the Web pages. In response to the page accesses, the Web servers fetch the data for the Web pages from their corresponding storage devices and send the fetched data across the World Wide Web (the Web) to the users or customers of the Web site.

Each Web server controls a duplicate copy of the data on the Web server's storage device, so the page accesses may be routed to any one of the Web servers. The use of multiple Web servers and multiple copies of the data allows multiple page accesses to be serviced simultaneously, so the Web site can handle the relatively large number of page accesses.

Occasionally, some Web pages need to be added to, deleted from or modified on the Web site. To modify or add to the Web pages, new data must be stored on the storage devices, either in place of the previous data or in addition to the previous data. The new data is sent to each of the Web servers, which store the new data on their corresponding storage device.

While the Web server is storing the new data on its corresponding storage device, the ability of the Web server to respond to incoming page accesses is diminished or eliminated. Therefore, the users of the Web site will experience increased latency (i.e. a long waiting period) in accessing the Web pages of the Web site or will receive back an error message stating that the Web page cannot be found or is temporarily unavailable. In either case, the user's satisfaction with using the Web site may deteriorate, causing the Web site to lose users or customers.

An exemplary prior art storage system 100 for a Web site that services a relatively large number of page accesses is shown in FIG. 1. The storage system 100 typically includes a Web portal 102 (e.g. routers, switches and/or other networking devices), several Web servers 104, their corresponding storage devices 106, one or more production servers 108 and a local network 110 (e.g. an Ethernet local area network). The Web portal 102 is connected to the Web 112 and receives the page accesses from the users and sends back the Web pages to the users through the Web 112. The Web portal 102 routes the page accesses and the responses through the local network 110 to and from the Web servers 104. The Web portal 102 distributes the page accesses among the Web servers 104 generally evenly. Using file server software 114 and file system software 116, the Web servers 104 access their corresponding storage devices to respond to the page accesses.

The new data for updating the current Web pages on the storage devices 106 is developed on the production server 108, while the users continue to access the current Web pages of the Web site. When the new data is ready to be used on the Web site, the production server 108 transfers the new data across the local network 110 to each of the Web servers 104 individually. Each Web server 104 then updates the current Web pages on its corresponding storage device 106 with the new data.

Transferring the new data across the local network 110 once for each Web server 104 can cause a data transfer “bottleneck” on the local network 110. The data transfer bottleneck on the local network 110 increases the response time and latency experienced by the users of the Web site. Likewise, the involvement of the Web servers 104 in updating their corresponding storage devices 106 can take up processing time of the Web servers 104, further increasing the response time and latency experienced by the users. Additionally, in some circumstances, when the Web servers 104 are updating the Web pages on the storage devices 106, some of the Web pages will be inaccessible to the users since the file system software 116 typically does not permit simultaneous writing and reading of the same data, particularly when directory structures within the file system 116 are being modified.

It is with respect to these and other background considerations that the present invention has evolved.

### SUMMARY OF THE INVENTION

The present invention reduces or eliminates the latency and inaccessibility problems of accessing Web pages of a Web site during the updating of the Web pages in a storage system connected to the World Wide Web (the Web). The Web servers are not involved in transferring data in the updating procedure, so the processing time of the Web servers is used for servicing Web page accesses. Additionally, the Web page accesses are preferably satisfied from snapshot volumes of original volumes of data for the Web pages during the updating procedure, so the current Web pages remain accessible while the original volumes are being updated. The snapshot volume is a “point-in-time image” of the original contents of the volume that is about to be updated.

The storage system preferably includes a Web portal, more than one Web server, more than one storage device (each preferably corresponding to one of the Web servers) and at least one production server. The Web portal, the Web servers and preferably the production server are connected to a local network, such as an Ethernet network. The Web portal connects to the Web, receives Web page accesses from users across the Web and distributes or routes the page accesses to the Web servers through the local network. Each Web server responds to the page accesses by accessing the data on the Web server's corresponding storage device through a storage area network, such as a Fibre Channel switched “fabric,” to which the Web servers, the storage devices and the production server are connected.

When the data for the Web pages is to be updated, the production server sends the new data to the storage devices through the storage area network, without passing the new data through the Web servers or the local network. Thus, the Web servers and the local network are not involved in the data updating, so they continue to be primarily involved in handling user accesses to the current Web pages.

Before the production server starts sending the new data to the storage devices, the production server preferably instructs the storage devices to make snapshot volumes of the original volumes of the data for the current Web pages and then instructs the Web servers to use the snapshot volumes to satisfy the continuing Web page accesses. The formation of the snapshot volumes and the redirecting of the Web servers to the snapshot volumes may momentarily interrupt the handling of the Web page accesses, but not significantly. Thus, the Web servers and storage devices resume satisfying the Web page accesses with only a nominal interruption. For the Web pages for which the data is being updated, the prior data for the updated Web pages is captured in the snapshot volume, from which accesses to those Web pages are satisfied while the new data is written to the original volumes. The creation and management of the snapshot volume and the writing of the new data to the original volume can be handled on the storage devices so that Web page accesses have priority, so the users do not experience a significant latency in accessing the Web pages. After the data for the Web pages has been updated, the Web servers are instructed to redirect their handling of the Web page accesses back to the original volumes, and the storage devices are instructed to delete or deallocate the snapshot volumes.

The production server preferably sends the new data to only one of the storage devices, a primary storage device. The primary storage device then coordinates replication of the new data to each of the other storage devices through the storage area network. In this manner, the distribution of the new data across all of the storage devices occurs faster than if the production server sent the new data to each of the storage devices, since the storage devices typically have much greater data transfer rates than do the production servers. Additionally, the production server is more quickly freed up to perform other tasks, since the remainder of the distribution of the new data is handled by the primary storage device.

A more complete appreciation of the present invention and its scope, and the manner in which it achieves the above noted improvements, can be obtained by reference to the following detailed description of presently preferred embodiments of the invention taken in connection with the accompanying drawings, which are briefly summarized below, and the appended claims.

### BRIEF DESCRIPTION OF THE DRAWINGS

FIG. 1 is a block diagram of a prior art storage system for maintaining Web sites for the World Wide Web.

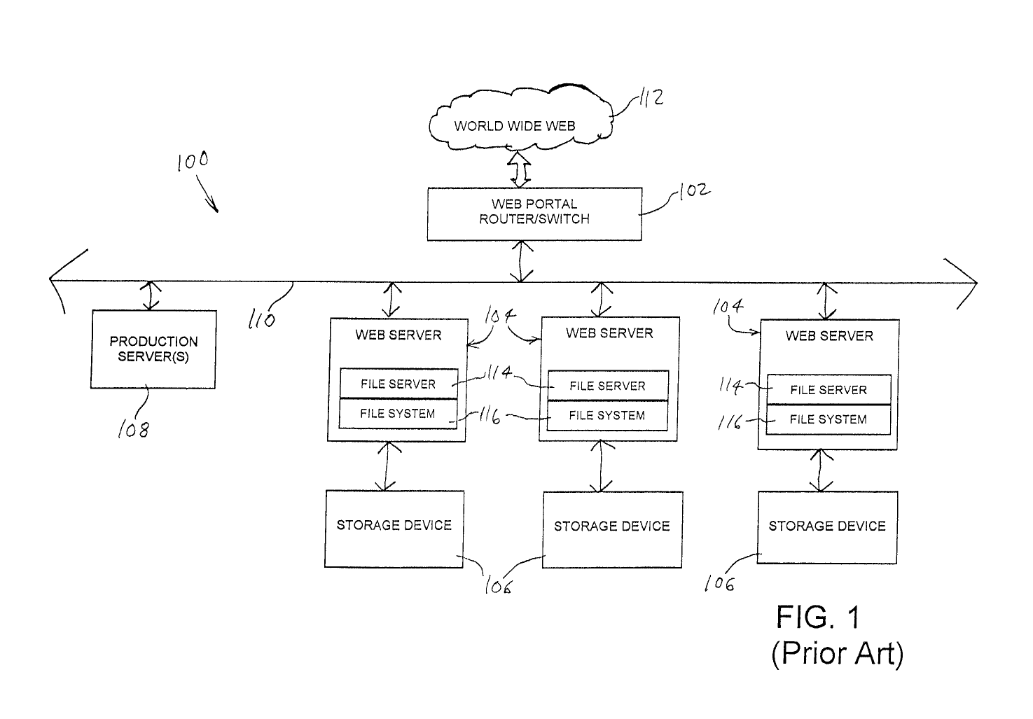

FIG. 2 is a block diagram of a storage system for maintaining Web sites for the World Wide Web incorporating the present invention.

FIG. 3 is a flowchart of a procedure to update data for Web pages of the Web site maintained on the storage system shown in FIG. 2.

### DETAILED DESCRIPTION

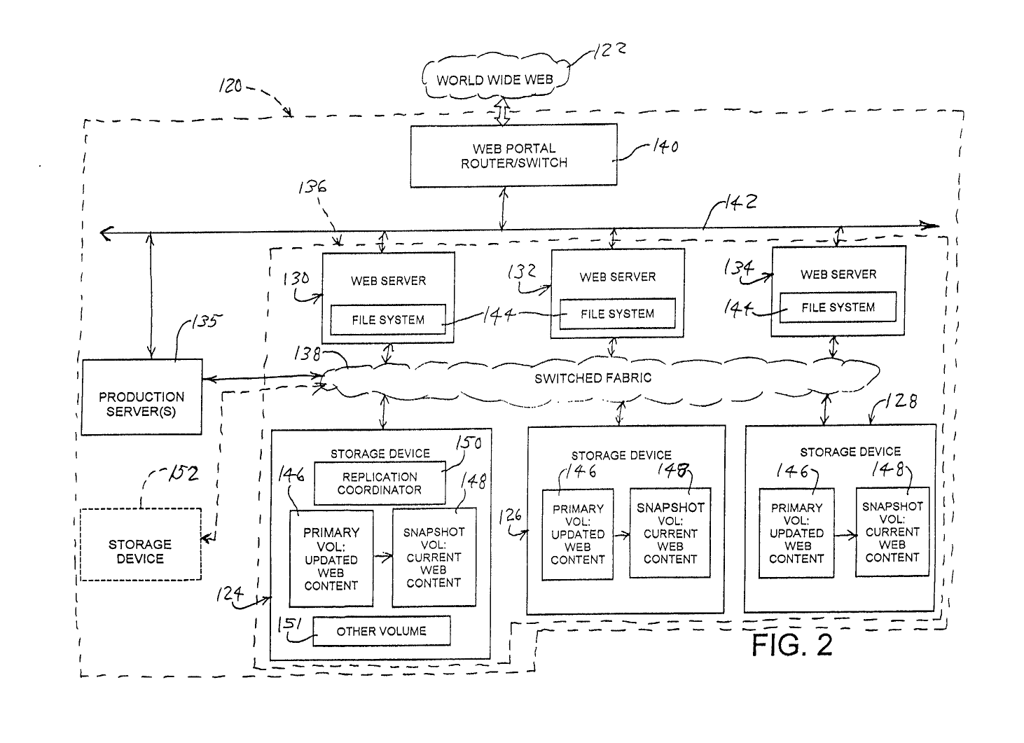

A storage system 120, as shown in FIG. 2, for maintaining one or more Web sites (not shown) for the World Wide Web (the Web) 122 generally includes several conventional storage devices 124,126 and 128 that are accessed by one or more conventional Web servers 130,132 and 134, typically on behalf of one or more conventional clients, users or customers (not shown) of the Web site. The storage system 120 also includes one or more production servers 135 with which an administrator of the storage system 120 manages the Web site and updates data for Web pages (not shown) of the Web site. The users access the Web pages of the Web site through the Web 122. The storage system 120 is typically part of a business or enterprise (not shown) that maintains its own Web site for its own customers or that maintains a variety of Web sites for a number of other businesses (not shown) that do not have the capability to manage a Web site.

The Web servers 130-134 and storage devices 124-128 form a storage area network (SAN) 136 with a switched fabric 138 (e.g. Fibre Channel), through which the Web servers 130-134 access the storage devices 124-128. Additionally, each storage device 124-128 typically contains a complete copy of the data for the Web pages of the Web site. Therefore, it is possible for any Web server 130-134 to access any storage device 124-128 through the switched fabric 138 to satisfy the Web page accesses. However, each storage device 124-128 typically corresponds to one Web server 130-134, respectively, and each Web server 130-134 typically is limited to accessing only its corresponding storage device(s) 124-128.

The storage system 120 also includes a conventional Web portal 140 through which the Web page accesses enter the storage system 120 from the Web 122. The Web portal 140 typically includes conventional routers, switches and other communication or networking devices (not shown). The Web portal 140 connects to and communicates with the Web servers 130-134 of the SAN 136 through a local network 142, such as an Ethernet network. The Web portal 140 routes the Web page accesses to the Web servers 130-134 in a manner that distributes the “load” on each of the Web servers 130-134 generally evenly.

When a user sends a Web page access for a desired Web page on the Web site through the Web 122 to the storage system 120, the Web portal 140 receives the Web page access and routes it across the local network 142 to one of the Web servers 130-134. The Web server 130-134, using conventional file system software 144, interprets the Web page access and sends a data read command through the switched fabric 138 to its corresponding storage device 124-128 to read the data for the desired Web page. The corresponding storage device 124-128 returns the data for the desired Web page through the switched fabric 138 to the Web server 130-134. The Web server 130-134 sends the data for the desired Web page through the local network 142 to the Web portal 140. The Web portal 140 forwards the data for the desired Web page across the Web 122 to the user.

Development of the Web pages for the Web site occurs on the production server 135. The Web pages are designed, coded and tested on the production server 135. Ongoing changes or updates to the content of the Web pages contained in a primary volume 146 on the storage devices 124-128 may occur on the production server 135 while the current content of the Web pages is accessible to users of the Web site through the Web 122.

When the updated content is ready for dissemination to the storage devices 124-128 in order to change the content of the Web site, the production server 135 issues a command through the switched fabric 138 to the storage devices 124-128 to create a snapshot volume 148 of the primary volume 146. The production server 135 then instructs the Web servers 130-134, through either the local network 142 or the switched fabric 138, to use the snapshot volume 148 on the corresponding storage devices 124-128 to satisfy the Web page accesses. Alternatively, the production server 135 sends a command to the Web servers 130-134 to form and begin using the snapshot volumes 148 on the storage devices 124-128.

The formation of the snapshot volumes 148 and the redirecting of the Web servers 130-134 to the snapshot volumes 148 may momentarily interrupt the handling of the Web page accesses, but not significantly. Thus, the Web servers 130-134 and storage devices 124-128 resume handling the Web page accesses with only a nominal interruption. After the Web servers 130-134 have been redirected to the snapshot volumes 148, the production server 135 sends the updated data to the storage devices 124-128 for storage in the primary volumes 146. Updating the primary volumes 146 has no impact on the content of the associated snapshot volumes 148. Additionally, storing the new data in the primary volumes 146 is preferably handled by the storage devices 124-128 so as to minimize the effect on the continuing Web page accesses sent by the users. Several conventional techniques are available for implementing “snapshot” behavior, so that the snapshot volumes 148 reflect a point-in-time image of the primary volumes 146 from which they were created. In one embodiment, whenever a block of data or a file in the primary volume 146 is to be updated with a portion of the new data, the previous data in the data block or file is copied to a repository (not shown) for the snapshot volume 148. When the Web servers 130-134 send the data read commands to the snapshot volume 148 for the previous data, the snapshot volume 148 first looks for the previous data in its repository and, if not found, then turns to the primary volume 146.

Preferably, the production server 135 sends the updated data only to one of the storage devices (e.g. storage device 124). The storage device 124 then uses replication coordinator software 150 to replicate the updated data to the other storage devices 126 and 128. The storage devices 124-128 typically have faster data transfer speeds relative to the production server 135, so using the production server 135 to distribute the updated data to only one storage device 124 and using the storage device 124 to distribute the updated data to the other storage devices 126 and 128 is faster and more efficient than using the production server 135 to distribute the updated data to all of the storage devices 124-128. Therefore, any added latency experienced when the users access the Web site will be minimized. Additionally, the production server 135 is more quickly freed up to perform other tasks. After the primary volume 146 has been updated on each of the storage devices 124-128, the production server 135 instructs the Web servers 130-134 to redirect the data read commands back to the primary volumes 146. The user of the Web site experiences an immediate change in the content of the Web pages of the Web site. After the Web servers 130-134 resume using the primary volumes 146, the storage devices 124-128 delete or deallocate the snapshot volumes 148.

The data with which the production server 135 redevelops or changes the content of the web pages may be stored on either another volume 151 on the storage device 124 or a separate optional storage device 152 before it is copied to the primary volumes 146 during the updating procedure. If stored on the separate storage device 152, then the production server 135 reads the data from the separate storage device 152 and writes it to the storage device 124 in order to update the data of the Web pages. If stored on the other volume 151 on the storage device 124, then the production server 135 either reads the data from the storage device 124 and writes it back to the storage device 124 for storage in the primary volume 146 or, if the storage device 124 supports it, the production server 135 issues a command to the storage device 124 to internally transfer the new data directly to the primary volume 146.

Alternatively, the production server 135 uses the primary volume 146 in the storage device 124 as the location in which to store the changed data during redevelopment of the Web pages. In this case, the snapshot volume 148 is formed on the storage device 124 and the Web server 130 is redirected to the snapshot volume 148 before starting the redevelopment of the Web pages. Thus, the Web server 130 uses the snapshot volume 148 for as long as it takes (minutes, hours, days, etc.) the system administrator to work with and redevelop the data in the primary volume 146 on the storage device 124. When the system administrator is finished with the redevelopment, the updated data in the primary volume 146 on the storage device 124 is replicated to the other storage devices 126 and 128, using the snapshotting technique described above. The Web servers 130-134 are then redirected back to the primary volumes 146 and the storage devices 124-128 are instructed to delete or deallocate the snapshot volumes 148. In an alternative, the snapshot volumes 148 are formed on all of the storage devices 124-128 and all of the Web servers 130-134 are redirected to the snapshot volumes 148 on the corresponding storage devices 124-128, respectively, before starting the redevelopment of the Web pages. In this case, the system administrator works with the data in the primary volume 146 on the storage device 124, but with each incremental change to the primary volume 146 on the storage device 124, the change is quickly replicated to the other storage devices 126 and 128. Therefore, when the redevelopment is completed, there is no further replication of the data required before the Web servers 130-134 are redirected back to the primary volumes 146.

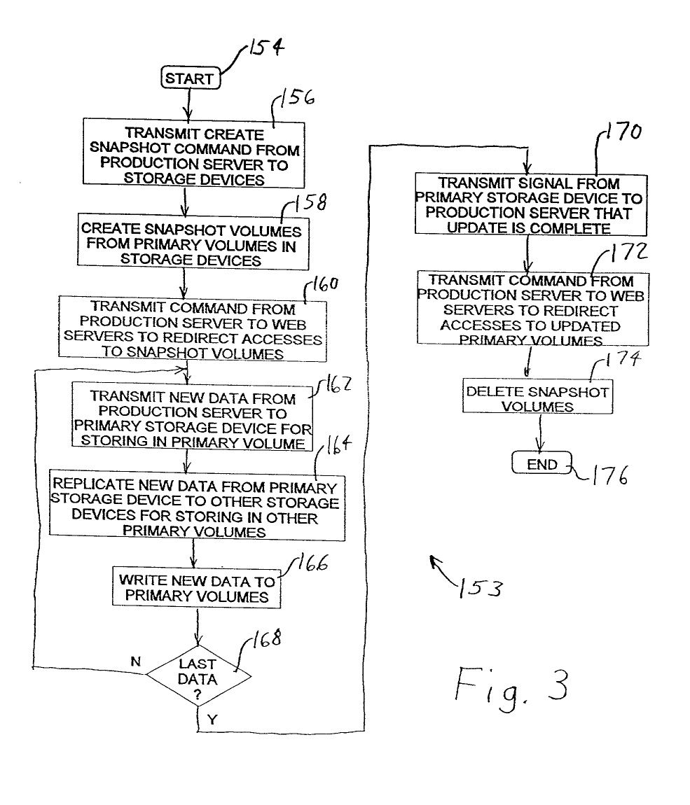

An exemplary procedure 153 for the storage system 120 to update the data for the Web pages of the Web site is shown in FIG. 3. The procedure starts at step 154. At step 156, a command to create the snapshot volumes 148 (FIG. 2) from the primary volumes 146 (FIG. 2) is transmitted from the production server 135 (FIG. 2) to the storage devices 124-128 (FIG. 2). The snapshot volumes 148 are created (step 158) from the primary volumes 146 in the storage devices 124-128. A command for the Web servers 130-134 (FIG. 2) to redirect their data accesses from the primary volumes 146 to the snapshot volumes 148 in the corresponding storage devices 124-128, respectively, is transmitted (step 160) from the production server 135 to the Web servers 130-134. The new data, or a portion thereof, with which the current data for the Web pages is to be updated, is transmitted (step 162) from the production server 135 to the storage device 124 (primary storage device for updates) for storing in the primary volume 146 therein. The new data is replicated (step 164) by the replication coordinator 150 from the primary storage device 124 to the other storage devices 126 and 128 for storing in the other primary volumes 146. The new data is written (step 166) to the primary volumes 146 in each of the storage devices 124-128. If the new data that was just written to the primary volumes 146 is not the last portion of the total data for the update, as determined at step 168, then the updating procedure 153 returns to step 162 to transmit the next portion of the new data. Once the last portion of the total data has been transmitted, as determined at step 168, the production server 135 is signaled (step 170) that the updating is complete. This signal may be a conventional confirmation by the primary storage device 124 that the last portion of the data was received and written. A command for the Web servers 130-134 to redirect their data accesses from the snapshot volumes 148 to back the primary volumes 146 in the corresponding storage devices 124-128, respectively, is transmitted (step 172) from the production server 135 to the Web servers 130-134. The snapshot volumes 148 are deleted (step 174) or deallocated in the storage devices 124-128. The updating procedure 153 ends at step 176.

The present invention has the advantage of permitting updates to the data of Web pages of a Web site without significantly adversely affecting the experience of users of the Web site. The users do not experience, as they did in the prior art, the increased latency in accessing the Web pages nor the occasional, albeit temporary, unavailability of the Web pages. The use of a SAN 136 to enable access between the Web servers 130-134 and the corresponding storage devices 124-128, respectively, further enables direct access between the production server 135 and the storage devices 124-128. In this manner, the production server 135 sends the new data for updating the Web pages through the switched fabric 138 of the SAN 136 without passing the new data through the Web servers 130-134. Thus, the Web servers 130-134 are not involved in the updating of the data for the Web pages, so the Web servers 130-134 and the local network 142 remain primarily involved with servicing the user's Web page accesses. Additionally, the overall time for updating the data on all of the storage devices 124-128 is reduced by having the production server 135 send the new data only to one storage device 124, which uses its replication coordination capability to distribute the new data to the other storage devices 126 and 128 more quickly than can the production server 135. Furthermore, the interruption to the user's Web page accesses is almost negligible since the Web servers 130-134 access the snapshot volumes 148 during the updating of the primary volumes 146 and immediately redirect the accesses to the primary volumes 146 upon completion of the updating. In this manner, the users experience an immediate transition from the old Web content to the new Web content.

Presently preferred embodiments of the invention and its improvements have been described with a degree of particularity. This description has been made by way of preferred example. It should be understood that the scope of the present invention is defined by the following claims, and should not be unnecessarily limited by the detailed description of the preferred embodiments set forth above.

The invention claimed is:

1. A storage system for handling data accesses received through a shared network directed to content contained in the storage system, comprising:
at least one content server connected to the shared network to receive the data accesses and to respond to the data accesses by sending the content through the shared network;
a storage network connected to the content server;
at least one storage device connected to the storage network, containing current data for the content and from which the content server reads the current data for the content through the storage network; and
a production server connected to the storage network and with which new data is developed to update the current data for the content and which sends the new data through the storage network to the storage device, bypassing the content server.

2. A storage system as defined in claim 1 further comprising:
a plurality of the content servers, each connected to the storage network; and
a plurality of the storage devices, each connected to the storage network and corresponding to one of the content servers and containing duplicate copies of the current data for the content;
and wherein the production server sends the new data to a first one of the storage devices through the storage network, which sends the new data to other ones of the storage devices through the storage network.

3. A storage system as defined in claim 2 further comprising:
snapshot volumes of the current data for the content contained on each of the storage devices;
and wherein the content servers read the current data for the content from the snapshot volumes on the corresponding storage devices while the production server sends the new data to the first storage device and the first storage device sends the new data to the other storage devices.

4. A storage system as defined in claim 1 further comprising:
a local network connected between the shared network and the content server;
and wherein the production server bypasses the local network when sending the new data through the storage network to the storage device.

5. A method of managing a storage system for handling data accesses from a shared network directed to content of the storage system, the storage system including a content server, a production server and a storage device connected to each other by a storage network, the storage device containing current data for the content, the content server servicing the data accesses by reading the current data for the content from the storage device across the storage network and sending the current data through the shared network, the production server being used by an administrator to develop new data to update the current data for the content, comprising the steps of:
servicing the data accesses from the current data;
transmitting the new data from the production server through the storage network to the storage device, bypassing the content server;
replacing the current data on the storage device with the new data; and
servicing the data accesses from the new data.

6. A method as defined in claim 5, wherein the storage system includes a plurality of the content servers and a plurality of the storage devices, each of the storage devices corresponding to one of the content servers and containing a duplicate copy of the current data, comprising the further steps of:
distributing the data accesses to the content servers;
servicing the data accesses by the content servers from the current data contained on the corresponding storage devices;
transmitting the new data from the production server through the storage network to a first one of the storage devices;
replicating the new data from the first storage device through the storage network to other ones of the storage devices;
replacing the current data on each of the storage devices with the new data; and
servicing the data accesses by the content servers from the new data contained on the corresponding storage devices.

7. A method as defined in claim 6 comprising the further steps of:
forming a first snapshot volume of the current data in the first storage device before transmitting the new data from the production server to the first storage device;
forming other snapshot volumes of the current data in each of the other storage devices before replicating the new data from the first storage device to the other storage devices; and
servicing the data accesses by the content servers from the first and other snapshot volumes of the current data contained on the corresponding storage devices while transmitting the new data from the production server to the first storage device and replicating the new data from the first storage device to the other storage devices.

8. A method as defined in claim 7 comprising the further step of:
sending a command, before forming the first and other snapshot volumes, from the production server through the storage network, bypassing the content servers, to the storage devices instructing the storage devices to form the first and other snapshot volumes of the current data.

9. A method as defined in claim 8 comprising the further step of:
sending a command, after forming the first and other snapshot volumes, from the production server through the local network to the content servers instructing the content servers to service the data accesses from the first and other snapshot volumes of the current data.

10. A method as defined in claim 9 comprising the further step of:
sending a command from the production server through the local network to the content servers instructing the content servers to service the data accesses from the new data on the storage devices after transmitting the new data from the production server to the first storage device and replicating the new data from the first storage device to the other storage devices.

11. A method as defined in claim 5, wherein the storage system also includes a local network connected between the shared network and the content server, comprising the further step of:
transmitting the new data from the production server through the storage network to the storage device, bypassing the local network.

12. A method of developing and updating content on a storage system, the storage system being for handling data accesses from a shared network directed to the content, the storage system including a content server, a production server and a storage device connected to each other by a storage network, the storage device containing current data for the content in a primary volume, the content server servicing the data accesses by reading the current data for the content from the primary volume on the storage device across the storage network and sending the current data through the shared network, the production server being used by an administrator to develop new data to update the current data for the content, comprising the steps of:
instructing the storage device to form a snapshot volume of the primary volume containing the current data for the content;
instructing the content server to service the data accesses from the current data in the snapshot volume;
developing the new data for the content;
using the primary volume as storage during the developing to simultaneously update the current data in the primary volume with the new data; and
instructing the content server to service the data accesses from the updated data in the primary volume after completing the developing.

13. A method as defined in claim 12, wherein the storage device is a first storage device, the storage system includes a plurality of the content servers and a plurality of the storage devices, each of the storage devices corresponds to one of the content servers and contains a duplicate copy of the current data, comprising the further steps of:
replicating the new data from the first storage device through the storage network to other ones of the storage devices;
updating the current data on the other storage devices with the new data; and
servicing the data accesses by the content servers from the new data contained on the corresponding storage devices.
